(19) United States
(12) Patent Application Publication
(10) Pub. No.: US 2026/0341834 A1
(43) Pub. Date: Oct. 29, 2026

(54) Immersion Cooling Module

(71) Applicants: SK Innovation Co., Ltd., Seoul (KR); SK On Co., Ltd., Seoul (KR)

(72) Inventor: Se Hyeon KIM, Daejeon (KR)

(21) Appl. No.: 19/655,922

(22) Filed: Apr. 23, 2026

(30) Foreign Application Priority Data
Apr. 25, 2025 (KR) 10-2025-0054864

(51) Int. Cl. H01M 10/6555; H01M 10/613; H01M 10/6557

(52) U.S. Cl. CPC H01M 10/6555; H01M 10/613; H01M 10/6557

(57) ABSTRACT

An immersion cooling module, which includes a cooling plate comprising one or more cooling channels formed in a longitudinal direction thereof, and flow apertures formed on interface surfaces of the cooling plate, the flow apertures fluidly communicating with the cooling channels to allow cooling fluid through the cooling channels to come into direct contact with battery cells stacked on opposite surfaces of the cooling plate.

### CROSS REFERENCE TO RELATED APPLICATION

The present application claims priority to Korean Patent Application No. 10-2025-0054864, filed Apr. 25, 2025, the entire contents of which are incorporated herein for all purposes by this reference.

### BACKGROUND

### Field

The present disclosure relates to an immersion cooling module.

### Description of the Related Art

Recently, demand for not only the miniaturization and weight reduction of mobile information terminals such as mobile phones and laptops, but also for higher energy capacity in electric and hybrid vehicles, has led to the development and use of various batteries as power sources.

The efficiency of secondary batteries (e.g., rechargeable batteries) is becoming increasingly important depending on their application fields, but issues related to various external factors, such as heat generation and fires during charging or operation may occur.

Conventional battery cooling systems typically employ indirect cooling methods in which a cooling fluid flows through sealed channels within a cold plate and does not directly contact the battery cell surfaces. While such systems provide thermal management, they are limited by the thermal resistance of the cold plate wall separating the cooling fluid from the battery cells. Immersion cooling, in which a dielectric cooling fluid directly contacts the battery cell surfaces, offers improved thermal performance but presents challenges in designing cooling plate structures that (1) provide sufficient direct contact between the cooling fluid and battery cell surfaces, (2) maintain structural rigidity of the battery module, and (3) allow adjustment of cooling performance for battery cells at different positions within the module.

Accordingly, various techniques are being developed to enhance the operational efficiency of secondary batteries and ensure the safety. Furthermore, due to increased carbon emissions and global warming from recent growth in electricity consumption, there is a demand for more efficient mechanisms for operating devices and for improvement in cooling methods and maximized efficiency.

### SUMMARY

According to an aspect of the present disclosure, an objective of the present disclosure is to provide an immersion cooling module capable of increasing the cooling efficiency of a battery cell by directly cooling the battery cell as a cooling channel of a cooling plate formed on an interface surface of the battery cell is in fluid communication with a surface of the battery cell.

Another objective of the present disclosure is to provide an immersion cooling module, which is capable of maximizing the cooling efficiency of a cooling plate by variously designing a cooling channel formed on the cooling plate formed on an interface surface of a battery cell, and increasing the structural durability and reliability of the module to which the battery cell is coupled.

According to the first embodiment of the present disclosure, provided is an immersion cooling module comprising a cooling plate comprising one or more cooling channels formed in a longitudinal direction thereof, and flow apertures formed on interface surfaces of the cooling plate in fluid communication with the cooling channels; and battery cells stacked on opposite surfaces of the cooling plate, wherein the flow apertures allow cooling fluid flowing through the cooling channels to come into direct contact with the battery cells.

In this configuration, the flow apertures of the cooling plate may be formed to extend in a longitudinal direction of the cooling channels and to be in fluid communication with the cooling channels.

In certain embodiments, the thickness of a frame of the cooling plate formed in the direction crossing the cooling channel is configured to adjust the flow rate of the cooling fluid on a contact surface of each battery cell.

In certain embodiments, the flow apertures of the cooling plate may be formed to extend in a direction crossing the cooling channels and in fluid communication with the cooling channels.

According to a second embodiment of the present disclosure, the cooling channels of the cooling plate may include: a first cooling channel coming into contact with the battery cell coupled to a first surface of the cooling plate; and a second cooling channel physically separated from the first cooling channel by a vertical baffle and coming into contact with the battery cell coupled to a second surface of the cooling plate.

In certain embodiments, the vertical baffle is coupled to the horizontal baffles so as to be slidable along the horizontal baffles in a direction toward the first surface or the second surface of the cooling plate, thereby adjusting relative sizes of the first cooling channels and the second cooling channels.

In certain embodiments, the first cooling channel and the second cooling channel may be partitioned into a plurality of first cooling channels and a plurality of second cooling channels by horizontal baffles crossing the vertical baffle.

In certain embodiments, the horizontal baffles may be formed to be spaced from each other at predetermined intervals in a longitudinal direction of the vertical baffle, and opposite ends of each horizontal baffle may be coupled into direct contact with the battery cell at the first surface and the battery cell at the second surface.

In certain embodiments, each of the horizontal baffles may include flanges at both ends, each flange coming into contact with the surface of each battery cell.

According to a third embodiment of the present disclosure, immersion cooling module comprises: a cooling plate provided between opposite battery cells and comprising a fluid baffle having a zigzag shape bent in a first direction and a second direction at predetermined intervals, and forming a cooling channel between the bent portions in the first direction and the second direction; and battery cells stacked on opposite surfaces of the cooling plate.

In certain embodiments, the fluid baffle of the cooling plate may include: a first frame and a second frame coupled to opposite portions thereof, wherein the first frame and the second frame may be coupled to a first portion and a second portion of the zigzag shape of the fluid baffle, and may be open at the first portion and the second portion to be in fluid communication with a cooling channel formed by the fluid baffle.

According to a fourth embodiment of the present disclosure, an immersion cooling module may include: a cooling plate provided between opposite battery cells and including a corrugated wall; and battery cells stacked on opposite surfaces of the cooling plate.

In certain embodiments, the corrugated wall may be bent alternately in facing directions of the battery cells formed at both surfaces and be coupled to the battery cells respectively, so that the cooling channel may be formed to be in fluid communication with the battery cells and at least one surface of the facing battery cells at both surfaces may directly contact the cooling fluid.

The features and advantages of the present disclosure will be more apparent from the following detailed description based on the accompanying drawings.

According to the embodiment of the present disclosure, the cooling channel cooling the battery cell is configured to come into contact with the battery cell and to be in fluid communication with the battery cell, thereby improving the cooling performance of the battery cell.

In certain embodiments, the structural design of the cooling plate formed on the mating surface of the battery cell enhances rigidity and structural safety of a battery cell module, thereby increasing degrees of freedom and reliability in device design.

In certain embodiments, cooling performance is maximized by directly cooling the battery cells, which efficiently increases the operational performance and efficiency of devices that use the battery cells, thereby reducing carbon dioxide emissions.

### BRIEF DESCRIPTION OF THE DRAWINGS

FIG. 1 is a perspective view of an immersion cooling module according to a first embodiment of the present disclosure.

FIG. 2 is a front view of the immersion cooling module of FIG. 1.

FIG. 3 is a cross-sectional view of the immersion cooling module of FIG. 1.

FIG. 4 is a perspective view of a cooling plate according to the first embodiment of the present disclosure.

FIG. 5 is a perspective view of the immersion cooling module according to a modified example of the first embodiment of the present disclosure.

FIG. 6 is a front view of FIG. 5.

FIG. 7 is a sectional view of FIG. 5.

FIG. 8 is a perspective view of the cooling plate according to a modified example of the first embodiment of the present disclosure.

FIG. 9 is a perspective view of the immersion cooling module according to a second embodiment of the present disclosure.

FIG. 10 is a front view of FIG. 9.

FIG. 11 is a sectional view of FIG. 9.

FIG. 12 is a perspective view of the cooling plate according to a modified example of the second embodiment of the present disclosure.

FIG. 13 is a perspective view of the immersion cooling module according to the modified example of the second embodiment of the present disclosure.

FIG. 14 is a front view of FIG. 13.

FIG. 15 is a sectional view of FIG. 13.

FIG. 16 is a perspective view of the cooling plate according to a modified example of the second embodiment of the present disclosure.

FIG. 17 is a perspective view of the immersion cooling module according to a third embodiment of the present disclosure.

FIG. 18 is a front view of FIG. 17.

FIG. 19 is a sectional view of FIG. 17.

FIG. 20 is a perspective view of the cooling plate according to the third embodiment of the present disclosure.

FIG. 21 is a perspective view of the immersion cooling module according to a fourth embodiment of the present disclosure.

FIG. 22 is a front view of FIG. 21.

FIG. 23 is a sectional view of FIG. 21.

FIG. 24 is a perspective view of the cooling plate according to the fourth embodiment of the present disclosure.

### DETAILED DESCRIPTION OF THE DISCLOSURE

The terminology used to describe embodiments of the present disclosure is not intended to limit the present disclosure. It should be noted that expressions in singular may include expressions in plural unless the context clearly indicates otherwise.

In assigning reference numerals to components of the drawings, it should be noted that the same components are given the same reference numerals as much as possible even when they are shown in different drawings, and similar reference numerals are given to similar components.

The drawings may be schematic or exaggerated to illustrate embodiments. In the present document, expressions such as “has”, “may have”, “comprises”, “may comprise”, “includes”, or “may include” indicate the presence of corresponding characteristics (e.g., a numerical value, function, operation, or component such as a part), and do not exclude the presence of additional characteristics.

Terms such as “one”, “other”, “another”, “first”, “second”, etc. are used to distinguish one component from another, and components are not limited by the above terms.

As described below, an exemplary embodiment of the present disclosure will be described in detail with reference to accompanying drawings.

The immersion cooling modules described herein provide several advantages over known technology. For example, the cooling fluid flowing through the cooling channels comes into direct contact with the surfaces of the battery cells, rather than being separated from the battery cells by an intervening wall as in conventional indirect cooling systems. This direct contact significantly improves cooling performance by eliminating the thermal resistance that would otherwise exist between the cooling fluid and the battery cell surfaces.

Additionally, the adjustable partition wall structures of the second embodiment allow independent control of cooling fluid flow to battery cells on opposite surfaces of the cooling plate, enabling differential cooling rates for battery cells experiencing different thermal loads.

Furthermore, the cooling plate structures disclosed serve a dual purpose: they function both as a thermal management component and as a structural member. Additionally, in some embodiments, adjustable components are added, e.g., vertical and horizontal baffles, which can be moved relative to each other to adjust the relative sizes of the first cooling channels and the second cooling channels.

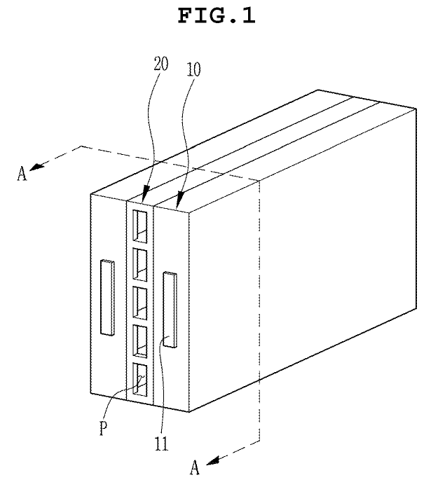

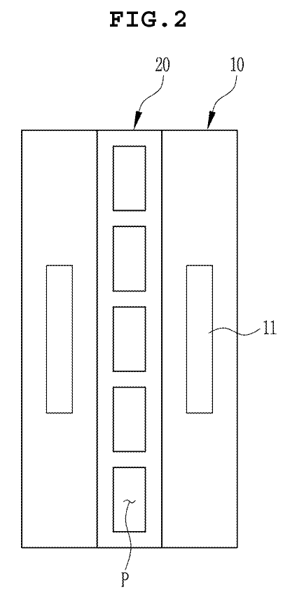

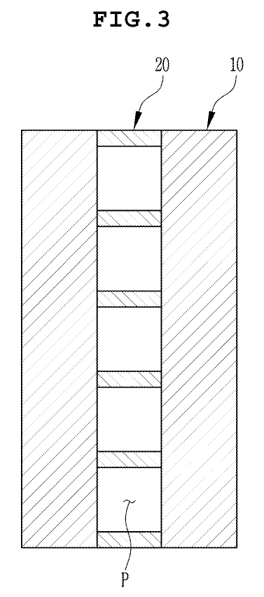

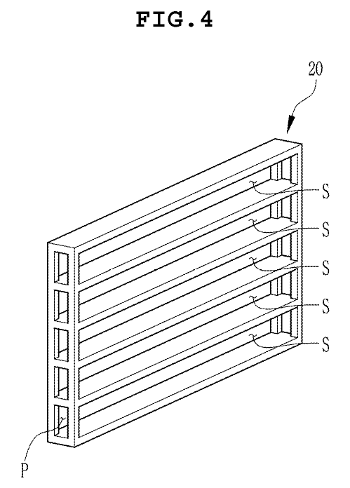

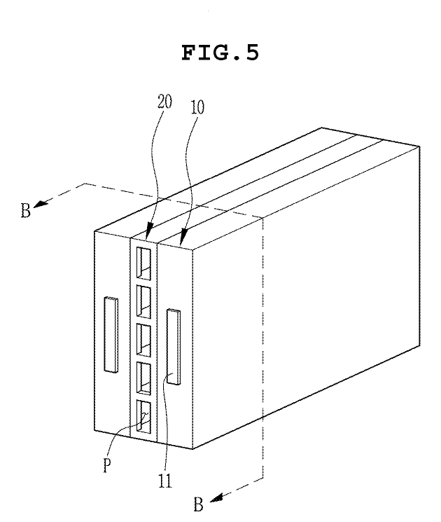

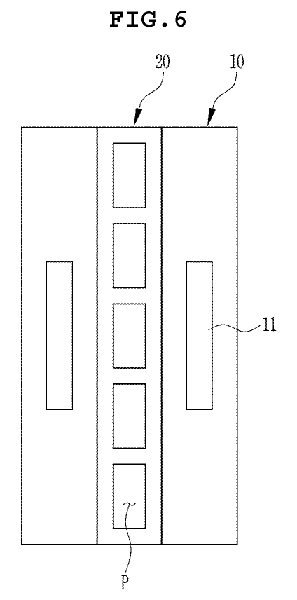

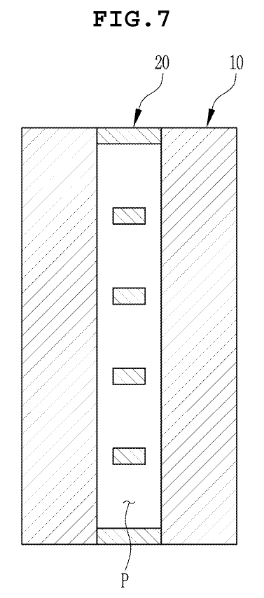

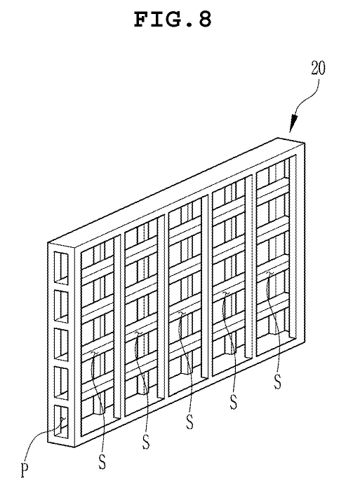

FIG. 1 is a perspective view of an immersion cooling module according to a first embodiment of the present disclosure. FIG. 2 is a front view of FIG. 1. FIG. 3 is a sectional view of FIG. 1. FIG. 4 is a perspective view of a cooling plate (also referred to as a “cold plate”) according to the first embodiment of the present disclosure. FIG. 5 is a perspective view of the immersion cooling module according to a modified example of the first embodiment of the present disclosure. FIG. 6 is a front view of FIG. 5. FIG. 7 is a sectional view of FIG. 5. FIG. 8 is a perspective view of the cooling plate according to a modified example of the first embodiment of the present disclosure.

According to the first embodiment of the present disclosure, the immersion cooling module includes a cooling plate 20 including at least one cooling channel P formed in a longitudinal direction thereof and flow apertures S formed on interface surfaces of the cooling plate, the flow apertures communicating with the cooling channels P to allow cooling fluid (also referred to “coolant” or “dielectric coolant”) flowing through the cooling channels P to come into direct contact with battery cells 10 stacked on opposite surfaces of the cooling plate 20.

As used herein, cooling fluid may be a dielectric fluid suitable for immersion cooling applications, such as, but not limited to, fluorinated fluids (e.g., 3M™ Novec™ engineered fluids or Fluorinert™ fluids), hydrocarbon-based fluids, or silicone-based fluids. Cooling fluid is selected to have low electrical conductivity, chemical compatibility with the battery cell materials, and thermal properties sufficient to absorb heat generated during charging and discharging of the battery cells.

As shown in FIGS. 1 and 2, in the immersion cooling module according to the embodiment of the present disclosure, the cooling plate 20 may be coupled to an interface surface on which a plurality of battery cells 10 is stacked. The battery cells 10 include various shapes of secondary batteries including an electrode tab 11, and include all of prismatic, cylindrical, or pouch-type secondary batteries, and the present disclosure does not limit the shape of the battery cells 10. However, in response to the types and shapes of secondary batteries, the design of the cooling plate 20 can be properly changed.

The battery cells 10 may be stacked and coupled to opposite surfaces of the cooling plate 20. The cooling plate 20 may be formed of a metallic material having high thermal conductivity and chemical resistance for immersion cooling. For example, a cooling plate 20 may be formed from aluminum. The cooling channels P are formed in the cooling plate 20, and fluid flowing in the cooling channels P may cool the battery cells 10 coupled to the opposite surfaces of the cooling plate.

As shown in FIG. 3, the cooling channels P of the cooling plate 20 may be designed to fluidly communicate directly with the battery cells 10 coupled to opposite surfaces of the cooling plate 20.

As shown in FIG. 4, the flow apertures S may be formed on each of opposite surfaces of the cooling plate 20 so that the cooling channels P in the cooling plate 20 is in fluid communication with a surface of each battery cell.

In this configuration, the flow apertures S of the cooling plate 20 are formed to extend in the longitudinal direction of the cooling channels P, and in fluid communication with the cooling channels P to allow the cooling fluid to directly cool a surface of each battery cell. The number or size of flow apertures S is not limited, but the proper structure design of the flow apertures S fluidly communicating with the cooling channels P may be changed in response to the location or size of the cooling channels P.

As shown in FIG. 4, the flow apertures S are formed in the longitudinal direction, i.e., a longitudinal direction of the cooling channel P, thereby facilitating the fluidity of the cooling fluid and simultaneously efficiently inducing direct contact between the cooling fluid and the surface of each battery cell 10.

In a modified example of the first embodiment of the present disclosure, the shape and structure of the flow apertures S on the opposite surfaces of the cooling plate 20 may be changed.

As shown in FIGS. 5 and 6, a perspective view and a front view of the immersion cooling module according to the modified example of the first embodiment of the present disclosure are the same as those in FIGS. 1 and 2 of the first embodiment of the present disclosure. However, as the modified example of the first embodiment of the present disclosure, as shown in FIGS. 7 and 8, at least one flow aperture S of the cooling plate 20 may be formed in a direction crossing the longitudinal direction of the cooling channels P. In this case, the thickness of a frame of the cooling plate formed in the direction crossing the cooling channels P is adjusted, thereby adjusting the flow rate of the cooling fluid on the contact surface of each battery cell. In other words, when the thickness of the frame in the direction crossing the flow direction of the fluid increases, the velocity of the cooling fluid in contact with the surface of each battery cell may be reduced due to fine disruptions in the flow of the cooling fluid. Accordingly, it is possible to prevent abrasion or damage to the battery cells due to contact between the cooling fluid and the surfaces of the battery cells.

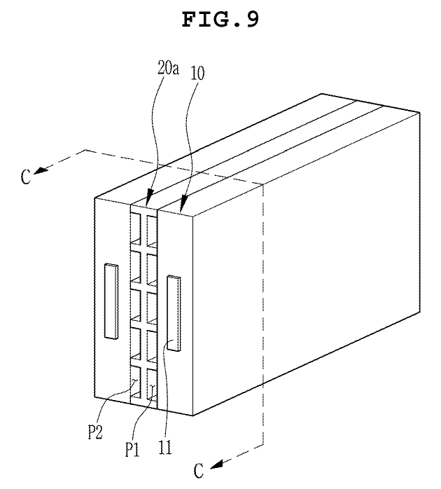

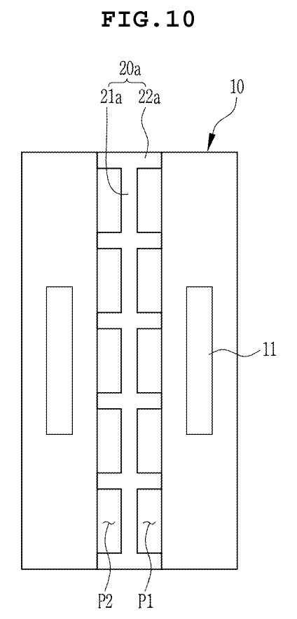

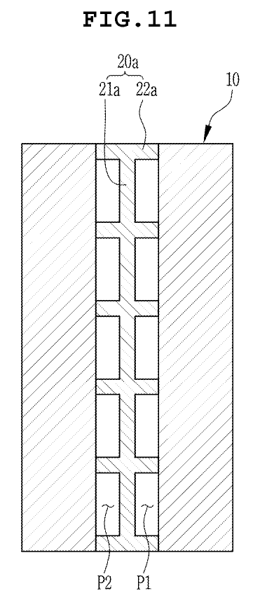

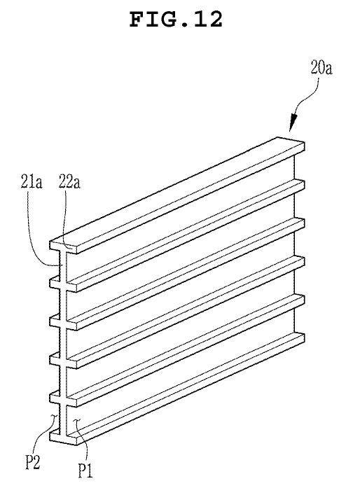

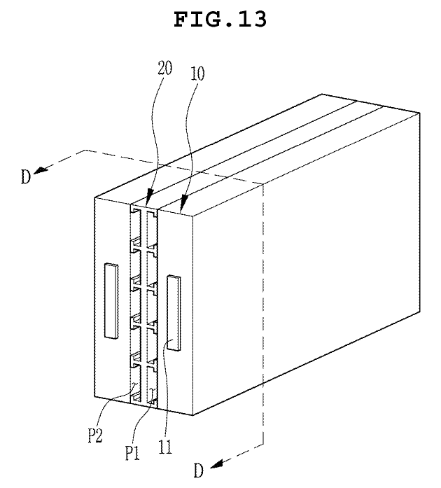

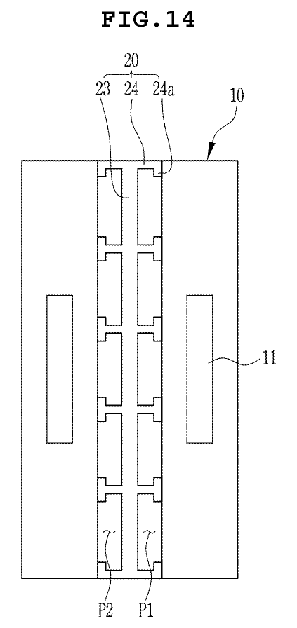

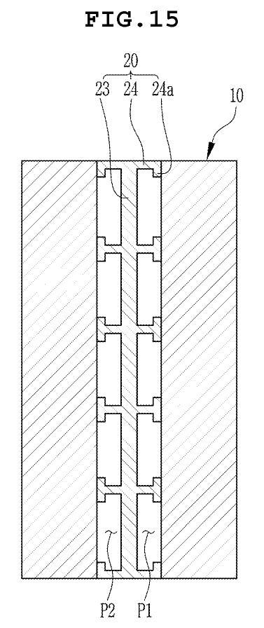

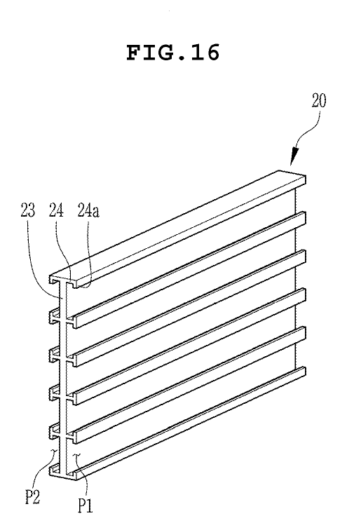

FIG. 9 is a perspective view of the immersion cooling module according to a second embodiment of the present disclosure. FIG. 10 is a front view of FIG. 9. FIG. 11 is a sectional view of FIG. 9. FIG. 12 is a perspective view of the cooling plate according to a modified example of the second embodiment of the present disclosure. FIG. 13 is a perspective view of the immersion cooling module according to the modified example of the second embodiment of the present disclosure. FIG. 14 is a front view of FIG. 13. FIG. 15 is a sectional view of FIG. 13. FIG. 16 is a perspective view of the cooling plate according to a modified example of the second embodiment of the present disclosure.

According to a second embodiment of the present disclosure, the immersion cooling module may be configured to physically divide the cooling channels of the cooling plate into first cooling channels P1 in which the cooling fluid flows while coming into contact with the battery cell at the first surface of the cooling plate, and second cooling channels P2 coming into contact with the battery cell coupled to a second surface of the cooling plate, by the vertical baffle. In other words, unlike the first embodiment of the present disclosure, the cooling channels P may include the first cooling channels P1 and the second cooling channels P2 physically divided.

Specifically, as shown in FIG. 9, the battery cells 10 may be stacked and coupled to opposite surfaces of the cooling plate 20a.

As shown in FIGS. 10 and 11, when viewed from the front side of the cooling plate 20a, a vertical baffle 21a at a central portion of the cooling plate 20a may physically divide the first cooling channels P1 and the second cooling channels P2.

The first cooling channels P1 may be provided such that the cooling fluid comes into direct contact with a surface of the battery cell 10 coupled to the first surface of the cooling plate 20a, and the second cooling channels P2 may be provided such that the cooling fluid comes into direct contact with a surface of the battery cell 10 coupled to the second surface of the cooling plate 20a. As described above, the first cooling channels P1 and the second cooling channels P2 in fluid communication with a surface of each battery cell such that the cooling fluid directly contacts the battery cells while the passages are physically divided from each other.

In other words, as shown in FIG. 12, the first cooling channels P1 and the second cooling channels P2 are formed to be open at the first surface and the second surface of the cooling plate, so that open side portions of the first cooling channels P1 and the second cooling channels P2 may serve as the flow apertures S.

As described in the first embodiment of the present disclosure, on the first surface and the second surface of the cooling plate, separate flow apertures may be formed on regions where the first cooling channels P1 and the second cooling channels P2 come in to direct contact with surfaces of the battery cells.

As shown in FIG. 12, according to the second embodiment of the present disclosure, the cooling plate 20a includes a plurality of first cooling channels P1 and a plurality of second cooling channels P2 by the vertical baffle 21a located at the central portion and dividing the cooling channel P and horizontal baffles 22a arranged to cross the vertical baffle 21a and extending toward both sides.

The horizontal baffles 22a are formed at the front surface of the vertical baffle 21a to be spaced at predetermined intervals in a longitudinal direction of the vertical baffle, and opposite ends of each of the horizontal baffles 22a may be coupled to the battery cell 10 at the first surface and the battery cell 10 at the second surface.

The position of the vertical baffle 21a relative to the horizontal baffle 22a may be adjusted, thereby adjusting the relative widths of the first cooling channels P1 and the second cooling channels P2 that come into contact with the battery cells 10 at the opposite surfaces.

In other words, although not shown in FIG. 12, the horizontal baffles 22a are coupled to the vertical baffle 21a such that the vertical baffle 21a is slidable along the horizontal baffles 22a in a direction towards the first surface or the second surface of the cooling plate 20a. By repositioning the vertical baffle 21a closer to the first surface or the second surface, the relative widths of the first cooling channels P1 and the second cooling channels P2 are adjusted, thereby increasing or decreasing the cooling rate for the battery cells 10 at the respective opposite surfaces.

The coupling method for adjustment as described above may use a known physical coupling method, although not shown in the drawings, the coupling method may use an insertion-coupling method in which coupling portions of the vertical baffle and the horizontal baffles are physically movable relative to each other. For example, an insertion-coupling method may include a slot-and-tab arrangement in which the vertical baffle 21a includes a longitudinal slot and the horizontal baffles 22a include tabs received within the slot, or a tongue-and-groove arrangement that permits sliding movement of the vertical baffle 21a relative to the horizontal baffles 22a.

FIGS. 13 - 16 are views showing the immersion cooling module according to a modified example of the second embodiment of the present disclosure.

FIG. 13 relates to a modified example of the second embodiment of the present disclosure, and opposite ends of the horizontal baffles 24 of the cooling plate 20b may include flanges 24a coming into contact with the surface of each battery cell 10.

As shown in FIGS. 14 and 15, the flanges 24a formed at the opposite ends of the horizontal baffles 24 may be configured to come into contact with surfaces of the battery cells 10 at wider widths, so that the cooling plate 20b may be stably coupled to the interface surfaces of the battery cells 10. As the cooling plate 20b ensures stable coupling and space with respect to the battery cells at the opposite surfaces, a flow of the cooling fluid through the cooling channel P of the cooling plate 20b may be maintained stably.

As shown in FIG. 16, the cooling plate 20b may secure structural rigidity due to coupling between the battery cells 10, as the flanges 24a are formed on opposite ends of each of the horizontal baffles 24. Similar to the second embodiment described above, the vertical baffle 23 is coupled to the horizontal baffles 24 such that the vertical baffle 23 is slidable along the horizontal baffles 24 in a direction toward the first surface or the second surface of the cooling plate 20b.

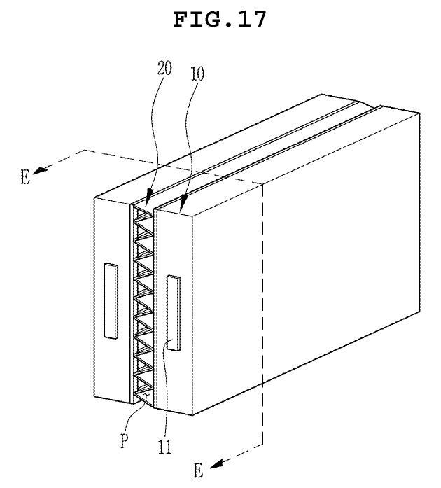

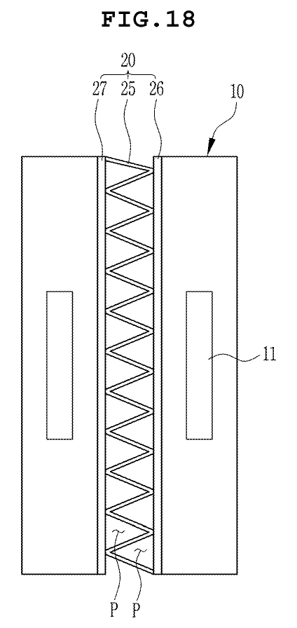

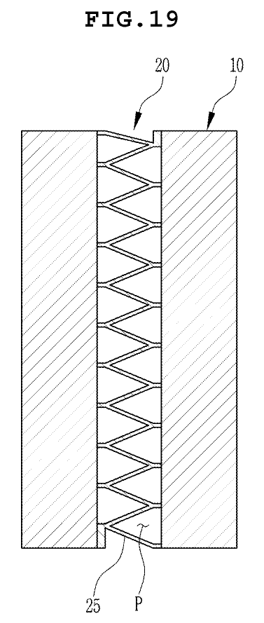

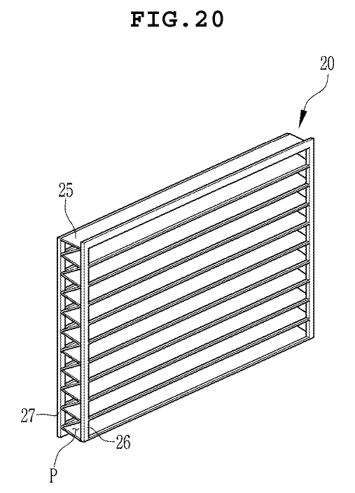

FIG. 17 is a perspective view of the immersion cooling module according to a third embodiment of the present disclosure, FIG. 18 is a front view of FIG. 17, FIG. 19 is a sectional view of FIG. 17, and FIG. 20 is a perspective view showing the cooling plate according to the third embodiment of the present disclosure.

According to the third embodiment of the present disclosure, the immersion cooling module includes the battery cells 10 stacked on the opposite surfaces, and the cooling plate 20c including a fluid baffle bent in a zigzag shape in a first direction and a second direction at predetermined intervals between the battery cells 10, forming cooling channels P between the portions bent in the first and second directions.

As shown in FIG. 17, the battery cells 10 are coupled to the opposite surfaces, and the cooling channels P are formed in the cooling plate 20c by the zigzag-bent fluid baffle 25 between the battery cells 10.

As shown in FIGS. 18 and 19, the fluid baffle 25 is formed in a zigzag shape, and the cooling channel P may be in fluid communication with the battery cells 10 so that the cooling fluid and the surfaces of the battery cells 10 come into contact with each other through apertures in the first direction and the second direction. As the degree and angle of the zigzag-bent shape of the fluid baffle 25 are adjusted, the number of the cooling channels P or the amount of a fluid flowing in the cooling channels P may be properly adjusted.

As shown in FIG. 20, the fluid baffle 25 may include a first frame 26 and a second frame 27 securely coupled to portions bent in the first direction and the second direction. In this case, the first frame 26 and the second frame 27 are coupled to the fluid baffle 25 at the first end and the second end of the fluid baffle 25 to fix the shape of the fluid baffle 25. Except for the portions where the first frame 26 and the second frame 27 are coupled to the fluid baffle 25, opposite side portions of the cooling plate 20 are open to be in fluid communication with the cooling channels P of the fluid baffle 25, so that the cooling fluid comes into direct contact with a surface of the battery cell 10, thereby increasing cooling efficiency.

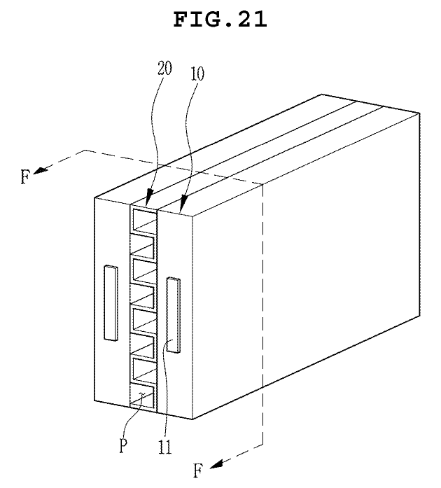

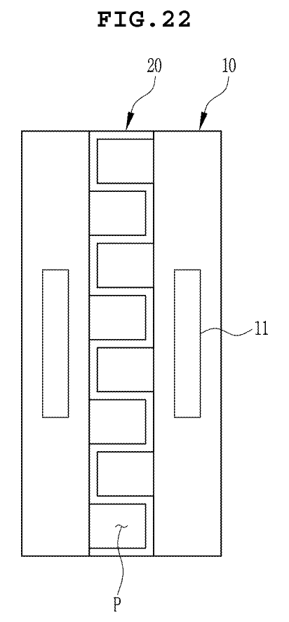

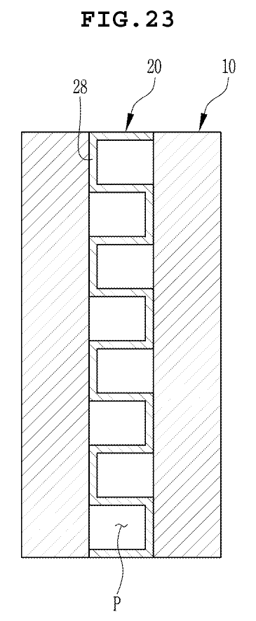

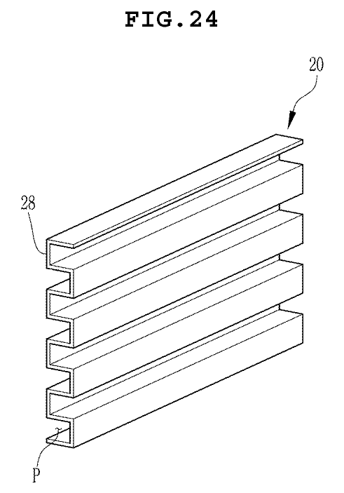

FIG. 21 is a perspective view of the immersion cooling module according to a fourth embodiment of the present disclosure. FIG. 22 is a front view of FIG. 21. FIG. 23 is a sectional view of FIG. 21. FIG. 24 is a perspective view of the cooling plate according to the fourth embodiment of the present disclosure.

According to the fourth embodiment of the present disclosure, the immersion cooling module includes the battery cells 10 stacked on the opposite surfaces, and a corrugated wall 28 located between the opposite battery cells 10 and extending in a first direction and a second direction at predetermined intervals.

As shown in FIG. 21, the battery cells 10 are coupled and stacked on the opposite surfaces. As shown in FIG. 22, the corrugated wall 28 forms the cooling channels P.

As shown in FIGS. 22 and 23, the corrugated wall 28 may form the cooling channel P successively while forming a space between the battery cells 10 at the opposite side surfaces. According to the fourth embodiment of the present disclosure, when the corrugated wall 28 of the cooling plate 20d extends in one direction, the corrugated wall may come into contact with the surfaces of the battery cells 10 at a predetermined length. As shown in the drawings, the corrugated wall 28 is coupled to be bent perpendicularly alternately in facing directions of the battery cells 10 formed on the opposite surfaces of the cooling plate 20c, so that the cooling channels P may be in fluid communication with the battery cell to allow at least one surface of the facing battery cells 10 and the cooling fluid to directly contact each other.

In certain embodiments, the immersion cooling module may further include inlet and outlet ports (not shown in the drawings) fluidly connected to the cooling channels P for supplying and returning the cooling fluid. The inlet and outlet ports may be connected to an external cooling circuit comprising a pump, a heat exchanger or radiator, and a fluid reservoir. The immersion cooling module may be housed within a sealed enclosure to contain the dielectric cooling fluid and prevent leakage.

As described herein, immersion cooling modules have been described in detail through specific embodiments. The embodiments are provided to specifically describe the various contemplated attributes of the many embodiments.

What is claimed is:

1. An immersion cooling module comprising:
a cooling plate comprising one or more cooling channels formed in a longitudinal direction thereof, and flow apertures formed on interface surfaces of the cooling plate, the flow apertures fluidly communicating with the cooling channels; and
battery cells stacked on opposite surfaces of the cooling plate, wherein the flow apertures allow cooling fluid flowing through the cooling channels to come into direct contact with the battery cells.

2. The immersion cooling module of claim 1, wherein the flow apertures of the cooling plate are formed to extend in a longitudinal direction of the cooling channels and to be in fluid communication with the cooling channels.

3. The immersion cooling module of claim 1, wherein the flow apertures of the cooling plate are formed to extend in a direction crossing the cooling channels and to be in fluid communication with the cooling channels.

4. An immersion cooling module comprising:
a cooling plate comprising:
a vertical baffle dividing the cooling plate into a first cooling channel and a second cooling channel, wherein the first cooling channel is in fluid communication with a battery cell coupled to a first surface of the cooling plate and wherein the second cooling channel is in fluid communication with the battery cell coupled to a second surface of the cooling plate; and battery cells stacked on opposite surfaces of the cooling plate, wherein cooling fluid flowing through the first cooling channel comes into direct contact with the battery cell at the first surface, and cooling fluid flowing through the second cooling channel comes into direct contact with the battery cell at the second surface.

5. The immersion cooling module of claim 4, further comprising horizontal baffles extending from the vertical baffle toward the first surface and the second surface of the cooling plate, the horizontal baffles subdividing the first cooling channel and the second cooling channel into a plurality of first cooling channels and a plurality of second cooling channels, respectively.

6. The immersion cooling module of claim 5, wherein the horizontal baffles are formed to be spaced from each other at intervals in a longitudinal direction of the vertical baffle, and opposite ends of each horizontal baffle are coupled to directly contact the battery cell at the first surface and the battery cell at the second surface.

7. The immersion cooling module of claim 5, wherein each of the horizontal baffles includes flanges at both ends, each flange coming into contact with a surface of each battery cell.

8. An immersion cooling module comprising:
a cooling plate provided between opposite battery cells and comprising a fluid baffle having a zigzag shape bent in a first direction and a second direction at predetermined intervals, and forming a cooling channel between the bent portions in the first direction and the second direction; and
battery cells stacked on opposite surfaces of the cooling plate.

9. The immersion cooling module of claim 8, wherein the fluid baffle of the cooling plate comprises:
a first frame and a second frame coupled to opposite portions thereof,
wherein the first frame and the second frame are coupled to a first portion and a second portion of the zigzag shape of the fluid baffle, and are open at the first portion and the second portion to be in fluid communication with a cooling channel formed by the fluid baffle.

10. An immersion cooling module comprising:
a cooling plate provided between opposite battery cells and comprising a corrugated wall that is bent perpendicularly alternately in a first direction and a second direction at predetermined intervals; and
battery cells stacked on opposite surfaces of the cooling plate.

11. The immersion cooling module of claim 10, wherein as the corrugated wall is bent alternately in facing directions of the battery cells formed at both surfaces and is coupled to the battery cells respectively, the cooling channel is formed to be in fluid communication with the battery cells so that at least one surface of the facing battery cells comes into direct contact with the cooling fluid at the first surface and the second surface of the cooling plate.

12. A method of cooling battery cells, the method comprising: providing a cooling plate between battery cells stacked on opposite surfaces of the cooling plate, the cooling plate comprising one or more cooling channels formed in a longitudinal direction thereof and flow apertures in fluid communication with the cooling channels; and passing cooling fluid through the cooling channels such that the cooling fluid flows through the flow apertures and comes into direct contact with surfaces of the battery cells.

13. The immersion cooling module of claim 3, wherein a thickness of a frame of the cooling plate formed in the direction crossing the cooling channel is configured to adjust a flow rate of the cooling fluid on a contact surface of each battery cell.

14. The immersion cooling module of claim 5, wherein the vertical baffle is coupled to the horizontal baffles so as to be slidable along the horizontal baffles in a direction toward the first surface or the second surface of the cooling plate, thereby adjusting relative sizes of the first cooling channels and the second cooling channels.
